(19) United States
(12) Patent Application Publication
(10) Pub. No.: US 2009/0031185 A1
(43) Pub. Date: Jan. 29, 2009

(54) HYBRID ARQ SYSTEMS AND METHODS FOR PACKET-BASED NETWORKS

(75) Inventors: Ariton E. XHAFA, Plano, TX (US); Deric W. WATERS, Dallas, TX (US); Anuj BATRA, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/147,823

(22) Filed: Jun. 27, 2008

Related U.S. Application Data
(60) Provisional application No. 60/951,258, filed on Jul. 23, 2007.

(51) Int. Cl. H04L 1/18; G06F 11/07

(52) U.S. Cl. 714/751; 714/E11.023

(57) ABSTRACT

Systems and methods for hybrid automatic repeat-request (HARQ) communication, comprising a transmitter employing hybrid automatic repeat-request (HARQ) and able to retransmit an incorrectly received packet without differently re-encoding data bits. The transmitter is further able to select at least one bit from any in a set to forward in at least one retransmission. The set contains any bits punctured from an original transmission corresponding to the retransmission. Other embodiments transmit, by a transmitter using hybrid automatic repeat-request (HARQ), a packet containing at least one punctured bit, select—without differently re-encoding data bits—at least one bit from any in a set to forward in at least one re-transmission of an incorrectly received packet, and retransmit the packet with at least one different punctured bit. The set contains any bits punctured from an original transmission corresponding to the re-transmission.

### CROSS-REFERENCE TO RELATED APPLICATIONS

The present application claims priority to U.S. provisional patent application Ser. No. 60/951,258, filed Jul. 23, 2007, and entitled “Hybrid ARQ Methods for Packet-Based Networks”, hereby incorporated in its entirety herein by reference.

### BACKGROUND

As devices become increasingly mobile and interoperable, networks may be more than the customary established grouping of devices. Instead, or in some cases in addition, devices join and leave networks on an ad-hoc basis. Such devices may join an existing network, or may form a temporary network for a limited duration or for a limited purpose. An example of such networks might be a personal area network (PAN). A PAN is a network used for communication among computer devices (including mobile devices such as laptops, mobile telephones, game consoles, digital cameras, and personal digital assistants) which are proximately close to one person. Any of the devices may or may not belong to the person in question. The reach of a PAN is typically a few tens of meters. PANs can be used for communication among the personal devices themselves (ad-hoc communication), or for connecting to a higher level network and/or the Internet (infrastructure communication). Personal area networks may be wired, e.g., a universal serial bus (USB) and/or IEEE 1394 interface or wireless. The latter communicates via networking technologies consistent with the protocol standards propounded by the Infrared Data Association (IrDA), the Bluetooth Special Interest Group (Bluetooth), the WiMedia Alliance's ultra wideband (UWB), or the like.

Among recently emerging communication technologies—especially those needing high data transfer rates—various ultra-wideband (UWB) technologies are gaining support and acceptance. UWB technologies are utilized for wireless transmission of video, audio or other high bandwidth data between various devices. Generally, UWB is utilized for short-range radio communications—typically data relay between devices within approximately 10 meters—although longer-range applications may be developed. A conventional UWB transmitter generally operates over a very wide spectrum of frequencies, several GHz in bandwidth. UWB may be defined as radio technology that has either: 1) spectrum that occupies bandwidth greater than 20% of its center frequency; or, as is it is more commonly understood, 2) a bandwidth >500 MHz.

Next generation networks, such as those standardized by the WiMedia Alliance, Inc., increase the range, speed, and reliability of wireless data networks. One implementation of next generation networks utilizes ultra-wideband (UWB) wireless technology, specifically a MultiBand orthogonal frequency-division multiplexing (OFDM) physical layer (PHY) radio along with a sophisticated medium access control (MAC) layer that can deliver data rates up to 480 megabits per second (Mbps).

The WiMedia UWB common radio platform enables high-speed (up to 480 Mbps), low power consumption data transfers in a wireless personal area network (WPAN). The WiMedia UWB common radio platform incorporates MAC layer and PHY layer specifications based on MultiBand OFDM (MB-OFDM). WiMedia UWB is optimized for the personal computer (PC), consumer electronics (CE), mobile device and automotive market segments. ECMA-368 and ECMA-369 are international ISO-based specifications for the WiMedia UWB common radio platform.

In communication networks, many different mechanisms are used to improve reliability of communications. Two of the more well-known mechanisms are forward-error correction (FEC) codes and automatic repeat request (ARQ). FEC codes encode the data bits into code words that contain redundant information. This redundancy enables the receiver to correct errors introduced by the channel or other impairments.

The complexity of a communication system is often constrained by using a single FEC code, otherwise known as the mother code. The output of a convolutional FEC code is often punctured to generate additional code rates. A punctured codeword is created by deleting some of the bits from the original codeword. It may be understood that puncturing is also known as rate-matching in other technologies. For an example of puncturing to adjust code rates, suppose that five (5) data bits are encoded using a rate 1/2 code to produce ten (10) coded bits. In order to achieve a rate 5/6 code, the transmitter punctures four (4) of the coded bits and transmit the remaining six (6) coded bits. In this example, the effective coded rate is 5/6. However, as a result of increasing the coding rate by puncturing, the error protection decreases and the data rate increases.

The code rate defines the amount of redundancy introduced into the code word. For example, a code rate of 1/2 will produce a codeword that is twice as long as the number of data bits. In general, a lower coding rate enables more errors to be corrected; but this comes at the expense of increased overhead and lower throughput. However, the goal for a transmitter is to encode data using the highest coding rate possible that still provides a sufficiently small probability of error.

A receiver in the communication system processes the channel output to create a log-likelihood ratio (LLR) for each bit in the transmitted codeword. The LLR is a measure of the probability of the given bit having the value of zero or one. An LLR value of zero indicates that the bit is equally likely to be zero or one. The FEC decoder computes an LLR for each bit in the original un-punctured codeword. However, when a coded bit has been punctured, there is no information available to aid in the computation of the LLR. As a result, the receiver sets the LLR of all punctured bits to zero.

In systems implementing ARQ, a packet of information is sent from the transmitter to the receiver and then the receiver responds to the transmitter with either an acknowledgement (ACK) or a negative-acknowledgement (NAK). Additionally, the transmitter can assume the information was not correctly received if neither acknowledgement is received by the transmitter after a predetermined amount of time, normally set as a time-out value. If the information is not correctly received, the transmitter can resend the information again until it is correctly received.

Increasing demand for more powerful and convenient data and information communication has resulted in a number of advancements, particularly in wireless communication technologies. Despite the advancements, however, significant improvement in data transfer rates is sought.

### BRIEF DESCRIPTION OF THE DRAWINGS

For a detailed description of exemplary embodiments of the invention, reference will be made to the accompanying drawings in which:

FIG. 1 is a block diagram of encoding/decoding using a convolutional FEC code for retransmission, in which embodiments may be used to advantage;

FIG. 2 is a block diagram of encoding/decoding using a systematic linear block FEC code for retransmission, in which embodiments may be used to advantage;

FIG. 3 illustrates an exemplary stop-and-wait ARQ timing diagram in a wireless local area network;

FIG. 4 illustrates an exemplary timing diagram in which an ACK timeout occurs in a wireless local area network;

FIG. 5 illustrates an exemplary block ACK timing diagram in a wireless local area network;

FIG. 6 illustrates an exemplary high throughput signal field, such as might be employed in a multiple-input multiple output system, according to embodiments;

FIG. 7 illustrates an exemplary very high throughput signal field, according to embodiments;

FIG. 8 illustrates a hybrid ARQ (HARQ) bit indicator in an exemplary high throughput control field;

FIG. 9 illustrates an exemplary method for a receiver, according to embodiments;

FIG. 10 illustrates an exemplary method for a transmitter, according to embodiments; and

FIG. 11 illustrates a block diagram of a further exemplary method for a transmitter, according to embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In light of the foregoing background, embodiments provide systems and methods for enabling implementation of hybrid automatic repeat request (HARQ) to especially wireless networks, including without limitation, 802.11 technologies such as multiple-input multiple-output devices and systems, wireless logical area networks (WLAN), etc., as well as other packet-based networks such, but not limited to, ultra-wideband (UWB) devices and systems. HARQ is a variation of the ARQ scheme in which forward error correction (FEC) bits are added to existing error detection bits (e.g., turbo code, Reed-Solomon code, etc.). Until the present embodiments, HARQ could not be used in some networks and systems (for example, and not by way of limitation, UWB devices and WLAN systems) for a number of reason, including a lack of signaling protocol that would enable HARQ to be employed for these networks and systems without introducing significant processing overhead.

Although embodiments will be described for the sake of simplicity with respect to wireless communication systems, it should be appreciated that embodiments are not so limited, and can be employed in a variety of communication systems over a variety of physical mediums.

Embodiments provide lower probability of error and lower overhead than current ARQ mechanisms. When considered in the context of 802.11 system, for example, embodiments achieve a lower probability of error by the transmitter's ability to change the puncturing pattern without having to re-encode the original data bits. This ability is in sharp contrast with current ARQ mechanisms that must retransmit within the same TXOP (transmit opportunity) using the same data rate and puncturing pattern. The same ability of the transmitter—to change the puncturing pattern without having to re-encode the original data bits—also results in lower overhead processing resource-wise and reduces on-air time by retransmitting less data. At the same time, embodiments reduce system overhead by increasing the probability that re-transmitted packets will be successfully decoded, therefore requiring fewer retransmissions.

The media access control (MAC) layer and the physical (PHY) layer work together to transmit/extract data into/from the communication channel. Although embodiments will be described from the perspective of the PHY layer, it should be remembered that cooperation between MAC and PHY layers is important to support embodiments for encoding data for retransmission in a network.

Consider first PHY layer embodiments for the encoding for retransmission. Some embodiments employ a FEC code that is a convolutional code—although it should be appreciated that embodiments are not limited to only convolutional codes and may easily be extended to varieties of Low Density Parity Codes (LDPC), turbo codes and other advanced FEC codes. Embodiments increase the probability of successful decoding by puncturing a different set of bits when re-transmitting a data packet than those punctured during the previous transmission. This enables a receiver to reuse the LLR it computed for the codeword during the previous transmission—together with the LLR values it computes for the codeword during the current transmission—to thereby improve the probability of successful decoding.

In order to better understand the puncturing process of embodiments, some exemplary definitions are provided. Let N_{D} denote the number of data bits to be encoded into a single codeword by the transmitter, and N_{C} denote the number of data bits in the codeword encoded by the mother code. Let the codeword created by the mother code be defined as M=└m₁, m₂, . . . , m_{N}_{_{C}}┘, so that the mother code has rate R_{M}=N_{D}/N_{C}, where R_{M}≦1. The number of bits punctured is N_{C}−N_{P}, so that N_{P} bits remain in the final codeword. Let Cᵢ=[c₁⁽ⁱ⁾, c₂⁽ⁱ⁾, . . . , c_{N}_{_{P}}⁽ⁱ⁾] be the set of bits that remain in the codeword after puncturing during the i-th transmission, so that the FEC code has rate R_{M}=N_{D}/N_{P}, where N_{P}<N_{C}. Let Pᵢ=└P₁⁽ⁱ⁾, P₂⁽ⁱ⁾, . . . , P_{N}_{_{C}}_{-N}_{_{P}}⁽ⁱ⁾┘ be the set of punctured bits during the i-th transmission. The sets Cᵢ and Pᵢ are subsets of M. Let the indices of the elements of M that are contained in Cᵢ be denoted as Sᵢ. Let the indices of the elements of M that are contained in Pᵢ be denoted as S̅ᵢ. The sets Sᵢ and S̅ᵢ are disjoint, and Sᵢ∪ S̅ᵢ={1, 2, . . . , N_{C}}.

According to these definitions, when the same packet is retransmitted in a conventional system, Sᵢ=S and S̅ᵢ= S̅; in other words, the set of bits that are punctured does not change from one transmission to the next. Embodiments change the encoding process such that one or more of the elements in S̅ᵢ do not belong to S̅ᵢ₊₁. In other words, embodiments change the set of bits that are punctured during each retransmission. The receiver can use the LLR values computed during the current and previous transmission(s) to increase the probability that the data bits will be correctly decoded. For example, if an LLR has been computed for every bit, then the probability of decoding the data bits correctly is as small as if the mother code was not punctured. In other words, if

$${⋃}_{j = 1}^{i} {S}_{j} = \{ 1 , 2 , … , {N}_{C} \} ,$$

then the effective coding rate of the FEC code is the same as the coding rate of the mother code. Note that, depending upon embodiment, the information is either encoded only once or it is encoded in exactly the same way each time—thus, the set of bits available to be selected for puncturing remains identical for each retransmission of a packet or frame.

An example puncturing pattern can be described as follows. For a rate 2/3 convolutional code with a rate 1/2 mother code, let [X₀, X₁, X₂, X₃, X₄, X₅] be the source bits, and let [A₀, A₁, A₂, A₃, A₄, A5] and [B₀, B₁, B₂, B₃, B₄, B₅] be the two streams of encoded bits produced by the mother code. To achieve a coding rate of 2/3, the following bits are punctured: [B₁, B₃, B₅], which leaves the following bits to be sent (in the shown order) during the first transmission over the air: [A₀, B₀, A₁, A₂, B₂, A₃, A₄, B₄, A₅]. In a subsequent retransmission, there are seven possible combinations of punctured bits that could be transmitted: [B₁, B₃, B₅], [B₁, B₃], [B₁, B₅], [B₃, B₅], [B₁], [B₃], and [B₅]. If k punctured bits are transmitted, then the effective rate of the code at the receiver after it combines the transmissions is 6/(k+9). During the second retransmission, the system can transmit any of the remaining 2^{3-k}−1 possible combinations of punctured bits not yet sent or potentially retransmit some of the bits already sent during any previous transmission, including the original transmission.

For a rate 3/4 convolutional code with the same mother code let [X₀, X₁, X₂, X₃, X₄, X₅, X₆, X₇, X₈] be the source bits, and let [A₀, A₁, A₂, A₃, A₄, A₅, A₆, A₇, A₈] and [B₀, B₁, B₂, B₃, B₄, B₅, B₆, B₇, B₈] be the two streams of encoded bits produced by the mother code. To achieve a coding rate of 3/4, the following bits are punctured: [B₁, A₂, B₄, A₅, B₇, A₈], which leaves the following bits to be sent (in the shown order) during the first transmission over the air: [A₀, B₀, A₁, B₂, A₃, B₃, A₄, B₅, A₆, B₆, A₇, B₈]. In a subsequent retransmission, any one of the 2⁶−1 possible combinations of punctured bits that could be transmitted. Some examples of the combinations are: [A₂, A₅, A₈, B₁, B₄, B₇], and [A₅, A₈, B₁, B₄]. If k punctured bits are transmitted, then the effective rate of the code at the receiver after it combines the transmissions is 9/(k+12). During the second retransmission, the system can transmit any of the remaining 2^{6-k}−1 possible combinations of punctured bits not yet sent or potentially retransmit some of the bits already sent during any previous transmission, including the original transmission.

For a rate 5/6 convolutional code with a rate 1/2 mother code, let [X₀, X₁, X₂, X₃, X₄] be the source bits, and let [A₀, A₁, A₂, A₃, A₄] and [B₀, B₁, B₂, B₃, B₄] be the two streams of encoded bits produced by the mother code. To achieve a coding rate of 5/6, the following bits are punctured: [B₁, A₂, B₃, A₄], which leaves the following bits to be sent (in the shown order) during the first transmission over the air: [A₀, B₀, A₁, B₂, A₃, B₄]. In a subsequent retransmission, any one of the 2⁴−1 possible combinations of punctured bits that could be transmitted. Some examples of the combinations are: [A₂, A₄, B₁, B₃], and [B₁, B₃]. If k punctured bits are transmitted then the effective rate of the code at the receiver after it combines the transmissions is 5/(k+6). During the second retransmission, the system can transmit any of the remaining 2^{4-k}−1 possible combinations of punctured bits not yet sent or potentially retransmit some of the bits already sent during any previous transmission (including the original transmission).

It should be appreciated that the present embodiments are flexible enough to enable a bit which was punctured on the original transmission, and sent on a subsequent retransmission, is still available for selection in further re-transmissions from the set of originally punctured bits. For example, a bit that was punctured for the original transmission may be selected by embodiments to be part of every subsequent re-transmission. Alternatively, that same bit may be selected by embodiments to be subsequently forwarded on alternating re-transmissions, or it may never be selected at all to be re-transmitted. It should be readily apparent that a bit that was punctured for an original transmission may be subsequently re-transmitted using any desired puncture pattern—or even a randomly selected puncture pattern.

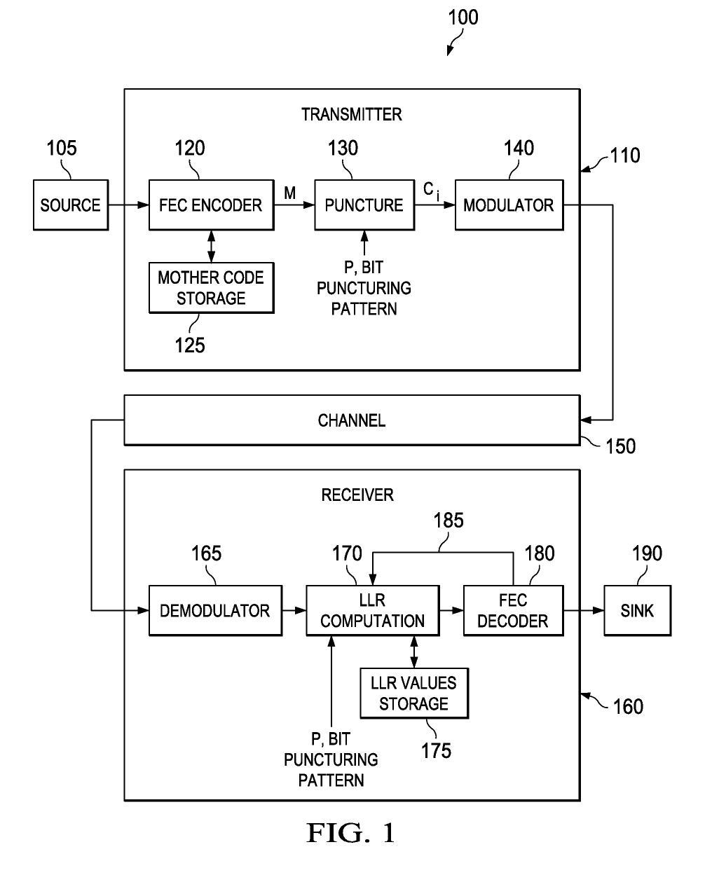

To better understand embodiments of this disclosure, consider FIG. 1 which illustrates a block diagram of such an exemplary encoding and decoding process. Source 105 provides the data bits to transmitter 110 to be transmitted through the communication channel 150. The data bits are subsequently encoded by FEC encoder block 120. Note that besides encoding the data bits with the FEC, depending upon the embodiment implementation, FEC encoder block 120 may also implement other optional features such as scrambling and interleaving. The codeword created by the FEC mother code in encoder 120 is then punctured (130) and modulated (140) before it is transmitted through channel 150. The input P at puncturer 130 indicates to encoder 120 which bits to puncture, and which bits to transmit. At receiver 160, the LLR for each bit in the codeword is computed (170); the method used to compute these LLR values is dependent on which bits were punctured since every transmission does not contain information about every bit in the codeword. Transmitter 110 and receiver 160 preferably agree about which bits were punctured. The computed LLR values are passed to FEC decoder 180 which decodes the codeword in order to estimate the input data bits. FEC decoder 180 improves performance further if it reuses a priori information from previous transmissions, which were incorrectly received, in its decoding. This a priori information may also be used by LLR computation block 170 (indicated by path 185). Note that FEC decoder 180 also reverses any optional features implemented by FEC encoder 120. Finally, the receiver's estimate of the data bits is output to data sink 190.

It should be appreciated that both transmitter 110 and receiver 160 have been illustrated for ease of discussion; either or both, however, may contain additional functional blocks depending upon implementation. For example, and not by way of limitation, an optional interleaver or scrambler may be implemented after the FEC encoding. It should be further appreciated that, in some embodiments, the FEC encoding function—represented as functional block 120—is implemented using multiple FEC encoders. In such embodiments, each FEC encoder creates a smaller codeword, and then each codeword is combined to create the final codeword. In such embodiments, the output of multiple FEC encoders can be viewed as one larger codeword.

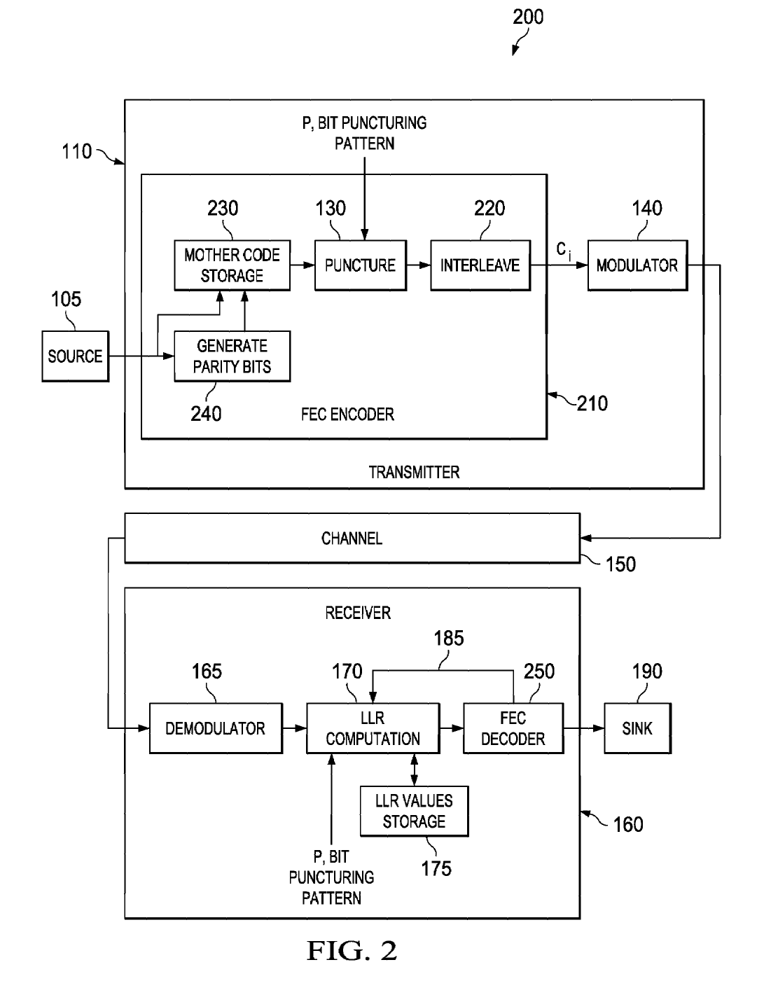

The data is either encoded only once or encoded in the same way each time; thus, the data bits available for selection by transmitter 110 for retransmissions remain exactly the same. Thus, in some embodiments, the initial output of FEC encoder 120 is stored instead of being recomputed for each retransmission; see for example, and not by way of limitation, mother code storage 125. In other embodiments, for example in systems where the puncturing occurs as part of the encoding block, the initially generated mother code is stored before a copy of the encoded bits are provided to be punctured; see for example, and not by way of limitation, mother code storage 230 of FIG. 2. In still other embodiments, FEC encoder 120 recreates the mother code—as opposed to storing it—which recreated mother code is then passed to puncturer 130 to puncture the bits of the mother code based on a different bit puncturing pattern. In such embodiments, the different bit puncturing pattern will puncture at least one different bit than was punctured when the encoded mother code was processed for the original (previous) transmission.

If receiver embodiments retain information about the LLR values computed during each retransmission, then—if it properly combines the LLR values of each transmission—the probability of error will decrease with each retransmission. For example, and not by way of limitation, some embodiments store the LLR values computed for bits sent during the original transmission, and the LLR values computed for any bit punctured in the original transmission which is sent in a subsequent retransmission, in LLR values storage 175. For example, some embodiments simply add the LLR values computed for each bit during each transmission as the preferred combination method. Therefore, to minimize the probability of error during retransmission of data packets, transmitter 110 can puncture the same number of bits from the original codeword while changing which bits are punctured. Each time a given bit in the codeword is transmitted, receiver 160 gains new information to aid decoding. Therefore, transmitter 110 preferably punctures as few bits as possible, to minimize the probability of error, while achieving the desired data rate.

To better appreciate how encoding according to present embodiments minimizes system overhead, consider that the coding rate is less than one in a conventional system. In other words, the number of bits punctured is less than the number of bits actually transmitted, |Sᵢ|>| S̅ᵢ. However, with present embodiments, when a codeword is being retransmitted, this constraint can be relaxed because receiver 160 can reuse information from previous transmissions. Embodiments of transmitter 110 retransmit at least one of the bits that were punctured in at least the immediately previous transmission. It should be appreciated that embodiments of transmitter 110 may instead retransmit at least one of the bits that were punctured in any of the previous transmissions of the packet or frame. The probability of error will decrease as more of the bits from the original codeword are transmitted assuming receiver 160 properly combines the LLR values of each transmission. Quantitatively, the effective coding rate after the i-th transmission is

$$R = {N}_{D} / \vert {⋃}_{j = 1}^{i} {S}_{j} \vert ,$$

and the probability of error decreases as the coding rate, R, decreases.

As an example of how system overhead can be reduced, consider a rate 5/6 codeword obtained from a rate 1/2 mother code. During the first transmission, 6 bits out of the 10 bit codeword are transmitted. Upon retransmission, the probability that the packet can be correctly decoded is increased if the transmitter sends at least one of the 4 bits that were punctured in the first transmission. If the receiver successfully decodes the packet after only one additional bit is transmitted, then fewer system resources have been used than if 6 —or more—of the originally transmitted codeword bits had been transmitted again. It should be appreciated that, during retransmission, the transmitter could instead send all four of the bits that were punctured during the first transmission to further—and more quickly—decrease the probability of error.

An alternative to a convolutional FEC encoder is a systematic linear block FEC encoder. FIG. 2 illustrates a block diagram of an exemplary system employing systematic linear block FEC codes. In such embodiments, as illustrated by FIG. 2, systematic linear block FEC encoder 210 of transmitter 110 takes the input data bits and computes a set of parity bits (240); the codeword it generates—which may be stored at mother code storage 230 or alternatively which may be passed directly to puncturing block 130 without first storing it—contains both the original data bits as well as the set of parity bits to provide error protection and/or correction capabilities. A larger number of parity bits indicate greater error protection from the code. At transmitter 110, the data bits from source 105 are used to compute a set of parity bits that, together with the original data bits, are passed into a puncturing block 130. The concatenation of the data bits and the parity bits creates a mother codeword. Transmitter 110 may choose not to transmit the entire mother codeword, in which case puncture block 130 removes some of the bits in the mother codeword to create a smaller codeword. In order for FEC decoder 250 of receiver 160 to recover the data bits from this smaller codeword, the smaller codeword preferably contains all of the original data bits. Puncture block 130 passes either the mother codeword or a smaller codeword to interleave block 220. Interleave block 220 shuffles the order of the bits in the codeword to avoid strings of consecutive erroneous bits at receiver 160. Note that if the data is being retransmitted, transmitter 110 may choose to puncture some of the data bits and/or some of the parity bits. The modulator and demodulator functions 140,165 may apply conventional techniques such that receiver 160 obtains a noisy copy of the transmitted codeword. Receiver 160 operates in much the same way as receiver 160 for a convolutional FEC code; only FEC decoder 250 is different. FEC decoder 250 de-interleaves the received codeword bits as a part of its processing, and then it outputs its estimate of the data bits to data sink 190. Optionally, receiver 160 may output a priori information to be used to help decode and/or compute the LLRs for a future retransmission.

With FEC embodiments, whether convolutional FEC or systematic linear block FEC, when data is being retransmitted, the probability of error can be reduced by transmitting a different set of parity bits so that eventually (after at least one re-transmission and depending upon the number of bits punctured from the original mother codeword) receiver 160 has a noisy version of the entire mother codeword. While each transmission has only a partial version of the mother codeword, receiver 160 must treat the missing bits as punctured, and fewer punctured bits means greater error protection. In order to save overhead, the retransmitted codeword may not contain any of the original data bits, or it may contain only a subset of the original data bits. If the retransmitted codeword contains some data bits or some parity bits from a previous transmission, then receiver 160 can combine the LLRs computed from each transmission of the bits.

Some background on the MAC layer, and how embodiments for encoding data for retransmission are supported by the MAC layer, will now be discussed. It is understood that in wireless networks, link layer error recovery enhances overall performance and supporting quality of service (QoS) in the network. The medium access control (MAC) error recovery in WLANs uses an ARQ approach. This approach is effective in WLAN because the round-trip delay is small. There are two types of ARQ mechanisms used in wireless networks for error recovery: stop-and-wait and selective-repeat ARQ mechanisms.

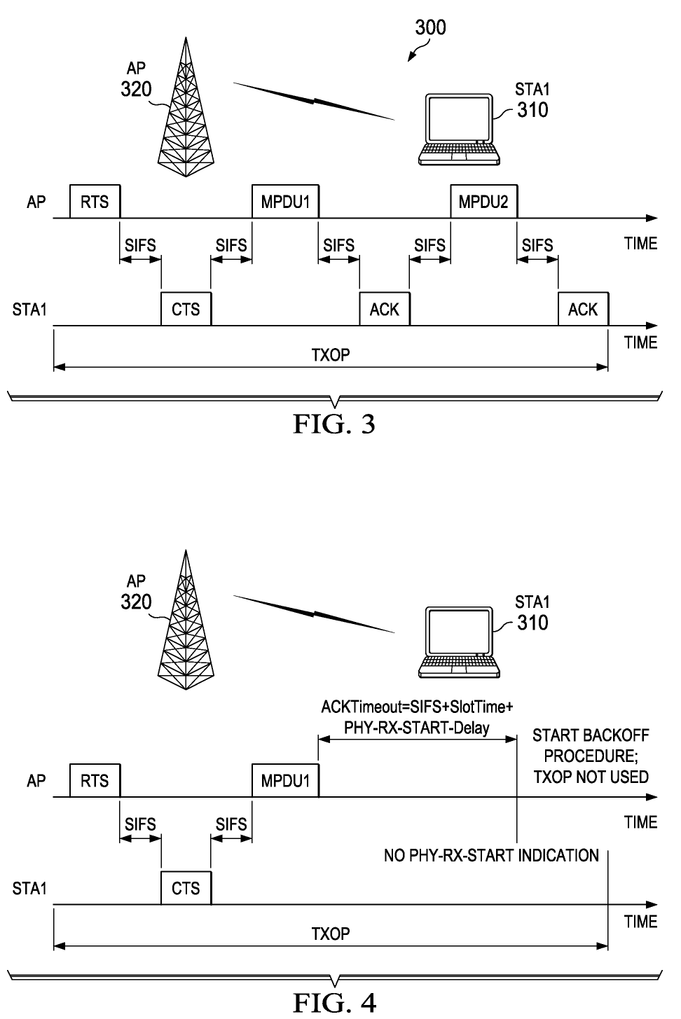

The ARQ mechanism most commonly used in WLAN is the stop-and-wait ARQ. In this approach, exemplarily illustrated in FIG. 3, AP 320 sends a request to send (RTS) message. After waiting a short interframe space (SIFS) time, STA1 310 replies with a clear to send (CTS) message. After waiting the SIFS, transmitting station 320 sends a data frame from its MAC protocol data unit (MPDU) and waits for an acknowledgement (ACK) by receiving STA 310. In the illustrated embodiment, transmitting station is AP 320 and the receiving station is STA1 310. The ACK is sent by receiving STA 310 if the data frame is correctly received. After waiting SIFS, AP 320 transmits the next batch of bits in the MPDU (identified as MPDU2 in FIG. 3). If, however, the data frame is incorrectly received, and as shown in FIG. 4, after a timeout, transmitting STA 320 defers and retransmits the same data frame the next time that it wins the contention for the wireless medium because further transmissions within this transmission opportunity (TXOP) are not used. It is important to note that the transmitting STA in a stop-and-wait system is not able to send another data frame (of the same access category) until the data frame is successfully received and acknowledged by the receiving STA or the maximum number of retransmissions is reached. If a timeout occurs (see FIG. 4), the transmitting STA, which in the illustration of FIG. 4 is assumed to be the access point (AP), will retransmit every bit in MAC protocol data unit 1 (MPDU1). It should be appreciated that although FIGS. 3 and 4 illustrate a RTX/CTS handshake between AP 320 and STA1 310, these figures are strictly exemplary, and such handshake is not to be considered a limitation.

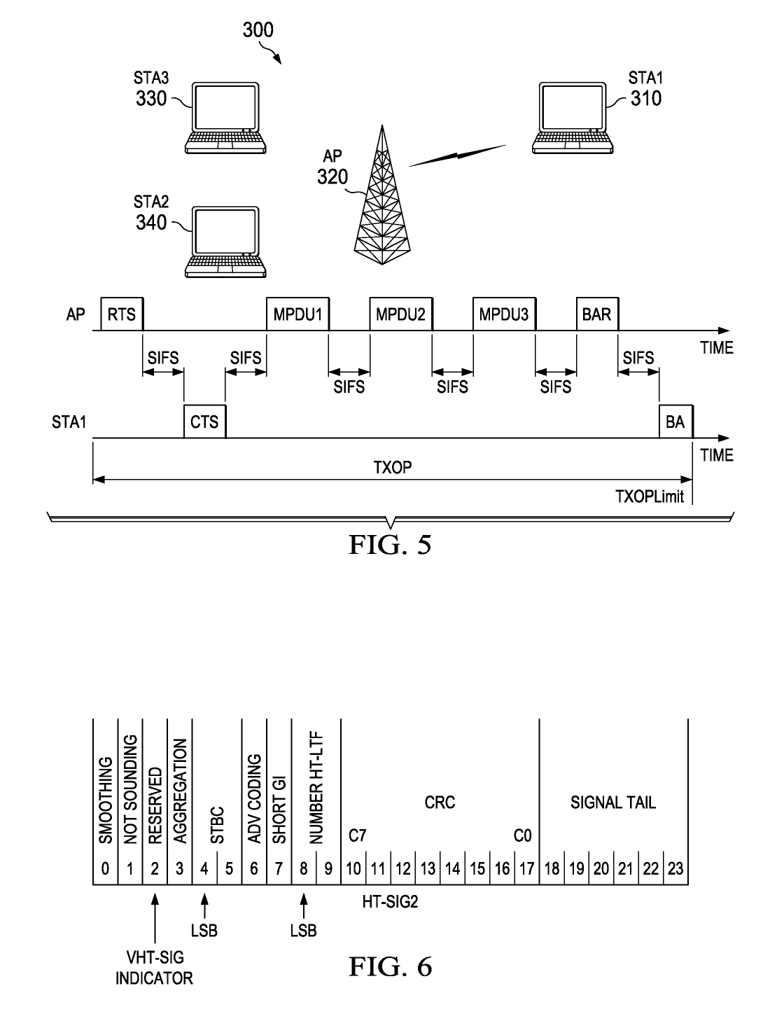

As can be easily appreciated, a stop-and-wait ARQ scheme incurs overhead due to the requirement to wait for immediate transmission of an ACK for each data frame. In the IEEE 802.11(e) standard, a selective-repeat ARQ mechanism called a block acknowledgement (BlockAck) is proposed. In this mechanism, a group of data frames can be transmitted one-by-one, each data frame separated by a short interframe spacing (SIFS) interval. Then, a single BlockAck frame is sent back to the sender to inform it how many packets have been correctly received. It is understood that the block-ACK mechanisms of IEEE 802.11(n) and IEEE 802.11(e) differ on the size of the block-ACK bitmap, as well as on the details of block-ACK implementation. Regardless, the 802.11(n) standard inherited from 802.11(e) the use of immediate and delayed block ACK mechanisms; however, it also added the new implicit block-ACK mechanism. It can be readily seen that block-ACK mechanisms improve channel efficiency since the receiver responds to multiple MPDU frames with a single ACK (see FIG. 5) instead of multiple ACKs for the same number of frames as was the case with a stop-and-wait ARQ scheme. The block ACK (BA) response frame identifies which individual MPDU frames were correctly received, or alternatively which individual MPDU frames need to be retransmitted because they were not correctly received. AP 320 transmits a Block ACK Request (“BAR”) upon completing the transmission of the last MPDU frame; after waiting the SIFS period, the Block-ACK (“BA”) is returned by STA1 310 identifying which individual MPDU frames were (or were not, depending upon implementation) correctly received. Once the AP 310 receives the BA response frame, it retransmits the failed MPDU frames exactly as before, depending on whether the predetermined threshold for number of retransmissions has been reached. It should be appreciated that although STA2 340 and STA3 330 are not transmitting (for ease of illustration), they are included to illustrate—without limitation—a possible network configuration, and could as easily be interacting with AP 320 as STA1 310.

The use of HARQ, in embodiments, in wireless networks increases robustness and reduces overhead associated with the aforementioned ARQ mechanisms. However, in some embodiments, the receiver requires some information beyond what exists in current state-of-the-art wireless network receivers to support implementation of HARQ. For example, this information may include an indication that the transmitted packet is using HARQ. In addition, supporting HARQ may require some new behaviors between transmitters and receivers of existing systems. It will be appreciated that although embodiments are described in the context of a wireless local area network (WLAN), this is for ease of understanding, and not by way of limitation. Further more, although specific examples of embodiments will be discussed, again, this is for ease of understanding, and not by way of limitation to these specific examples.

The following is information that would be useful to a receiver in order to provide improved support HARQ for WLANs. Embodiments provide this information to a receiver, or enable a receiver to calculate it, etc. A receiver may support HARQ with only a subset of the information listed, or it may support HARQ if it is also given additional information. In order for the PHY layer at the receiving device to be able to know to combine the LLR values of the incoming frame with those from a previously received frame, transmitter embodiments preferably forward the following information in the header of a retransmitted frame:
Destination indicator. Such an indicator designates whether this particular STA/device is the intended recipient of the packet. The PHY layer uses this information to avoid contaminating the LLR values it has stored from a previous incorrectly received packet that may be retransmitted later.
HARQ indicator. This bit indicates whether the packet belongs to a traffic flow that supports HARQ. The PHY layer uses this information to decide whether or not to save LLR values obtained for a particular packet.
Retransmission indicator. Such an indicator specifies whether the incoming packet is a retransmission of a previous packet. The PHY layer uses this information to decide whether or not to combine the LLR values computed for the current packet with LLR values computed for an earlier packet. In addition, this field may include a retransmission number so that problems do not arise if the receiver is unable to process the received packet.
Traffic ID (TID) indicator. This bit indicates the traffic category to which the packet belongs. The PHY layer uses this information to assign an LLR buffer to the incoming packet. This indicator is particularly useful if the receiver maintains an LLR buffer for each traffic category that uses the HARQ mechanism.
Puncturing bit indicator. The PHY layer uses this information to identify the bits in the codeword that correspond to the LLR values it has computed.

The above information could be obtained by the receiver from the transmitter in several ways depending upon the embodiment. For example, in some embodiments, the transmitter transmits the information before transmitting the data packet. In other embodiments, the transmitter transmits the information as part of the header with the data packet. In further embodiments, the transmitter and receiver negotiate or establish ahead of time some or all of the information regarding HARQ support. In still further embodiments, the rules that define transmitter/receiver behavior pre-establish some of the information in advance of transmission(s). In yet further embodiments, some of the information may be inferred from other parameters, or compressed into a smaller number of bits. It should be appreciated that these specifically identified embodiments are for illustration, and do not preclude other techniques—now known or developed in the future—for transmitting this information.

One way to define the destination indicator is according to the MAC address of the packet. The receiver would know—from all or part of the MAC address—whether it is the intended recipient of the packet. Other modes exist where the receiver can determine whether it is the intended recipient of a packet without any new exchange of information between transmitter and receiver, e.g., when an RTS/CTS (request to send/clear to send) message is used to reserve a TXOP. Another example is a Power Save Multi Poll (“PSMP”) mode when the receiver knows exactly when to expect the next packet.

One way to define the puncturing bit indicator is to establish the bit puncturing pattern for each subsequent transmission. In such embodiments, transmitter 110 and/or receiver 160 can independently count how many times a packet is retransmitted to know the puncturing pattern. Receiver 160 could use the value of the retransmission and TID indicators to reset the counter when appropriate. Transmitter 110 may communicate the value of its counter to the receiver in order to avoid problems when the receiver does not successfully process a previous transmission.

Note that the MAC layer can instruct the PHY layer whether or not to store LLR values and for how long, according to embodiments. The particular instructions will depend on whether the packet is correctly received and decoded at the MAC layer.

In WLANs—as they currently exist—the PHY layer does not need the destination, HARQ, retransmission, or TID indicators. However, the aforementioned information needs to be available in the PHY layer in order to support HARQ. Making this information available to the PHY layer duplicates efforts in the MAC and PHY layers. To circumvent this, in some embodiments, one could impose the rule that if an HARQ flow provides this information to the PHY layer (e.g., MAC address), then this information is not to be repeated in the MAC header. In other embodiments, the MAC portion of the frame is left unchanged, which results in an increase in processing overhead due to duplication of efforts in the MAC and PHY layers. In still other embodiments, only a portion of the information is duplicated in both layers. It should be appreciated that these approaches may be used separately or in combination, each consisting of a subset of the aforementioned information or, alternatively, more information can be included depending on the scenario and HARQ requirements.

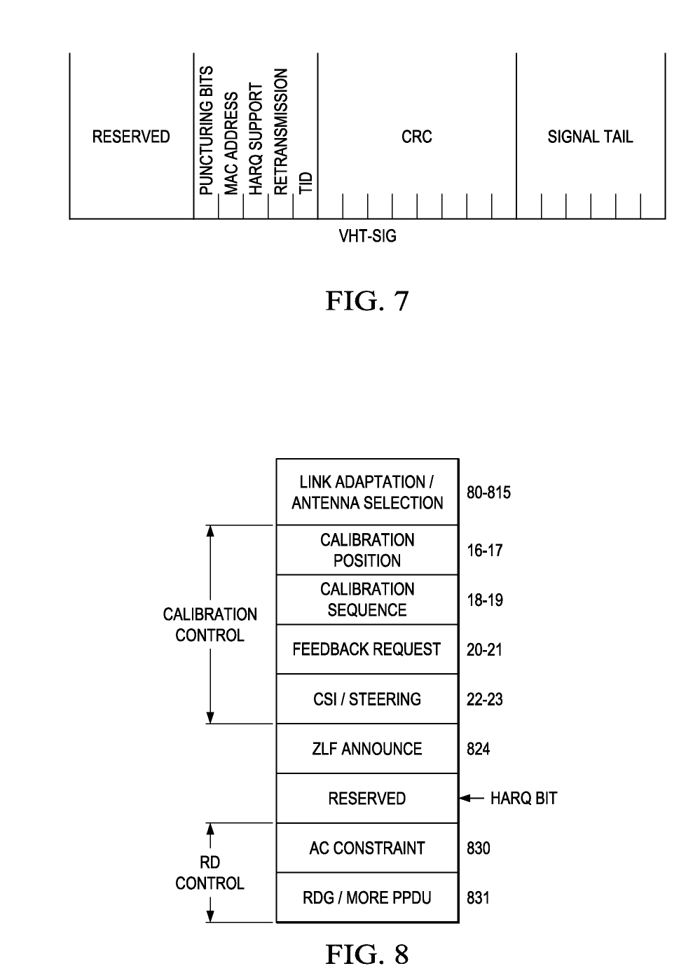

Some embodiments of the PHY layer take advantage of having destination, HARQ, retransmission, and/or TID indicators for a transmitted packet included in a Very High Throughput Signal (VHT-SIG) Field that is part of the preamble for each packet. The reserved bit in high-throughput signal field, HT-SIG2 (see FIG. 6), would indicate the presence of the VHT-SIG. An exemplary VHT-SIG field is illustrated in FIG. 7. In order to obtain the information to support HARQ, the PHY layer would simply decode the new VHT-SIG field and process the information.

It should be readily appreciated that the specific amount of data/bytes, the specific content used for indication, as well as which sub-field(s) are used in the VHT-SIG field are matters of design choice and can vary depending upon specific implementation; however, some or all of the aforementioned information for supporting HARQ should be communicated, e.g., MAC address (48 bits), HARQ indicator (1 bit), TID indicator (3 bits), puncturing bit indicator (1-3 bits), and retransmission indication (1 bit). To reduce the overhead associated with the MAC address, some embodiments assign the temporary identifications (IDs) to all the devices that use HARQ. In such embodiments, for example, it should be appreciated that an 8-bit field would be sufficient for the temporary IDs for 256 devices in the network. By assigning the TIDs, this reduces the overhead by 5 bytes. In order to maintain consistency with the structure used in the HT-SIG fields, cyclic redundancy code (CRC) and signal tail bits are included in the VHT-SIG field in some embodiments. Therefore, in such embodiments, these fields should be set at the transmitter end if the traffic flow supports HARQ. The exaction locations of these bits are not important, but rather that the information is conveyed in the VHT-SIG field.

FIG. 8 illustrates of an exemplary High-Throughput (HT) Control Field such as would be alternatively employed by other PHY layer embodiments. As can be seen, bits 25-29 are reserved; it should be understood that any of these bits can be used to indicate HARQ support for a particular frame. Under this scenario, MAC address, retransmission, as well as TID information can be retrieved from the MAC header of the packet. Hence, there is only one bit change in the HT control field, which considerably reduces the overhead added to the existing protocol. In some of these embodiments, the puncturing bit indicator is provided in PHY layer control protocol (PLCP) header, unless it is pre-negotiated or defined in the standard. In the latter case, the VHT-SIG field is present again, but it includes only information about the puncturing bits. Regardless, it should be appreciated that it is important that the receiving STA/device correctly decodes the HT Control Field. Therefore, in some embodiments, a more robust CRC is added to the MAC header to ensure that the information retrieved from the MAC header is correct, even if the packet is not correctly received.

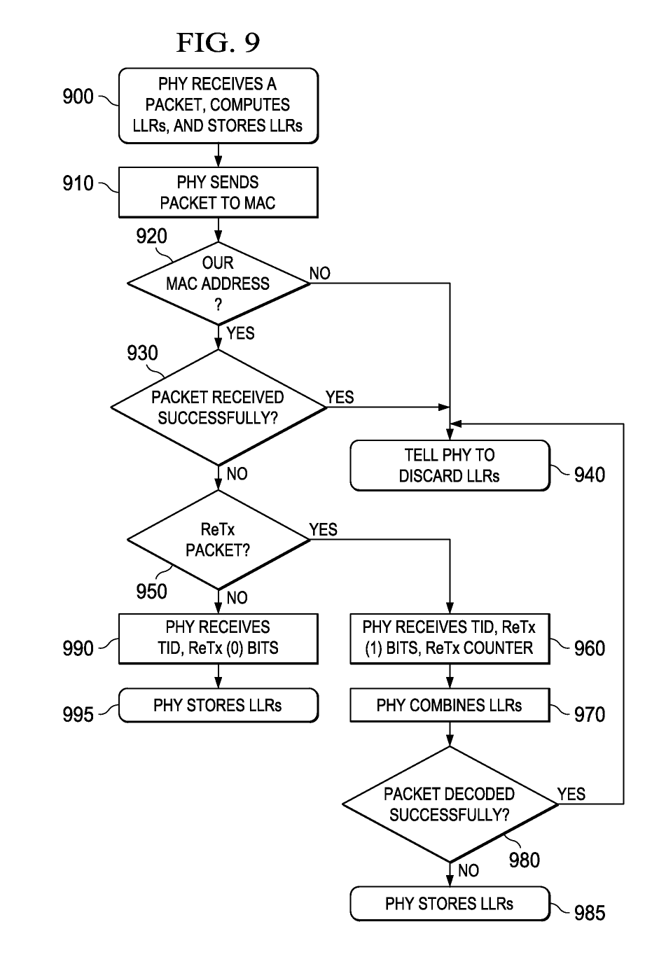

Furthermore, embodiments have the MAC layer provide to the PHY layer information on whether LLR values need to be stored and if so, in which TID buffer to store them. An exemplary flowchart of the handshakes between the MAC and PHY layers is illustrated in FIG. 9. Specifically, the PHY layer receives a packet, computes and stores the LLRs (block 900). The PHY layer sends the packet to the MAC layer (block 910) where it is determined whether the corresponding MAC layer is the intended recipient (block 920). If not, at block 940, the MAC layer instructs the PHY layer to discard the received LLR values. If, however, the MAC layer is the intended recipient, then the MAC layer determines whether the packet was successfully received (block 930). If the packet was successfully received, again the MAC layer instructs the PHY layer to discard the received LLR values (block 940). If, however, the packet was not successfully received, the MAC layer determines whether a new packet arriving is a retransmission packet (block 950). If this is not a retransmission packet, in other words it is an original transmission packet, the TID and retransmitted bits are received by the PHY layer (block 990) which layer stores the LLRs (block 995). If, however, the new packet arriving is a retransmission packet, the TID, retransmission counter and retransmission bits are received by the PHY layer (block 960). The PHY layer then computes the LLRs of the new retransmission packet and combines the results with the LLRs of the previous packet that was not successfully received (block 970). The MAC layer determines whether the packet was successfully decoded (block 980). If the packet was successfully decoded, the MAC layer instructs the PHY layer to discard the received LLR values (block 940). If, however, the packet was not successfully decoded, the MAC layer instructs the PHY layer to store the combined LLRs (block 985). This process repeats until the MAC layer can successfully decode the incoming packet, or the transmitter stops retransmitting the packet. It should be appreciated that the LLRs could alternatively be stored in other memory than that of the PHY layer. It should also be understood that processing blocks other than the MAC layer may instead be responsible for determining any or all of the decision functionality identified above.

As can be appreciated, the VHT-SIG field or a HARQ bit set in a high throughput control field describes at least some of the requirements at the receiver end; these fields or bit(s) are preferably set by the transmitting STA/device. Retransmission at the transmitting STA/device is preferably accomplished to meet its design objectives—and may depend on the metric that the STA/device decides to improve. In some cases, the exact PHY PDU is retransmitted, while in other cases, the PHY PDU may contain fewer bits to reduce the overhead of retransmission, and in some other cases the PHY PDU may be of the same size as the original PHY PDU, but with a different puncturing pattern.

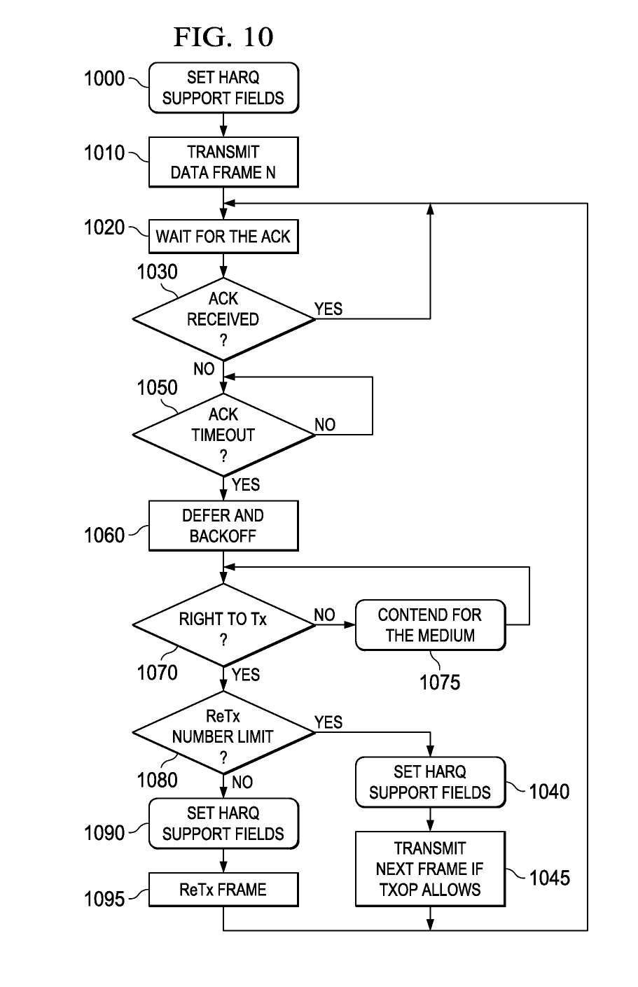

FIG. 10 illustrates an exemplary process for a transmitter for HARQ support. The HARQ bit is set in the PHY layer or the MAC header portion of the data frame (block 1000) and the particular data frame is transmitted (block 1010; the data frame is designated as DataFrameN, where N=a non-negative integer At block 1020, the transmitter waits to receive an acknowledgement (ACK). If it is received, the HARQ bit is set in the PHY layer or the MAC header portion of the next data frame (block 1040) and it is transmitted, assuming sufficient time remains in the current TXOP to complete the transmission. If no ACK is received, the transmitter determines whether the time period allocated for waiting for an ACK has lapsed (block 1050). If an ACK timeout has not occurred, the transmitter continues to wait; however, if an ACK timeout has occurred, then at block 1060, the transmitter defers and completes a backoff before contending again for a transmission opportunity. At block 1070, it is determined whether the transmitter has the right to transmit; if not, at block 1075 the transmitter continues to contend for the right to transmit across the medium. If, however, the transmitter has the right to transmit, it determines whether it has exceeded a predetermined number of transmissions (block 1080). If this limit has been exceeded, then the transmitter sets the HARQ bit in the PHY layer or the MAC header portion of the data frame (block 1040) and proceeds to transmit the next frame if the TXOP still allows (block 1045). If, however, the retransmission number limit has not be exceeded as determined at block 1080, then the transmitter sets the HARQ bit in the PHY layer or the MAC header portion of the data frame (block 1090) and proceeds to retransmit the frame (block 1095). The transmitter then again waits to receive an ACK.

Thus, if there is a retransmission, this indication is passed on to PHY layer, along with the decision of what puncturing bits to be used and other necessary information for HARQ. If a VHT-SIG is used to convey the information useful for HARQ support, then the MAC layer may populate a register that contains these fields and the PHY layer reads this information from that register. If a high throughput control field is instead used to convey the information useful for HARQ support, again, the MAC layer sets the HARQ bit in the HT Control Field as well as the puncturing bits in the VHT-SIG field. It should be appreciated that some embodiments use a RTS/CTS/CTS-to-self (CTS2S) handshake for HARQ flows. In such embodiments, RTS/CTS/CTS2S frames preferably contain a high throughput control field, which indicates HARQ support and the TID to be transmitted. If ACK Timeout occurs, the retransmitted packet may need to convey which bits are being punctured, unless they are pre-negotiated. In some embodiments, because the transmitter has ownership of the medium for the time interval defined by RTS/CTS frames, then, conveying other information such as MAC address and HARQ support in VHT-SIG is not necessary. While FIG. 10 illustrates the case when an immediate ACK is expected, a similar procedure can be followed for embodiments when BA agreement is used for the traffic flow.

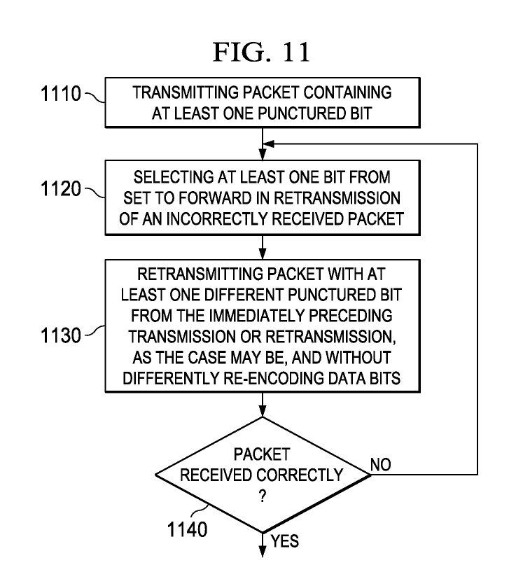

FIG. 11 illustrates an exemplary method of packet transmission according to embodiments. A transmitter transmits a packet in an original transmission using the hybrid automatic repeat-request (HARQ) protocol; the transmitted packet contains at least one punctured bit (block 1110). Upon receipt of an indication that the packet of the original transmission was incorrectly received, the transmitter changes its puncturing pattern to, in effect, select at least one bit from a set to include in the retransmission of the packet. The set contains any bits punctured from the original transmission corresponding to the retransmission (block 1120). The transmitter retransmits the packet with at least one different punctured bit—a different punctured bit from any forwarded in the immediately preceding transmission or retransmission, as the case may be—and without re-encoding data bits (block 1130). At block 1140, the transmitter waits for an acknowledgement of correct receipt of packet. If it receives this indication, then the transmitter readies itself for its next original transmission. However, if the transmitter does not receive this indication, or it receives an affirmative indication that the packet was yet again incorrectly received, the transmitter returns to block 1120 to prepare to retransmit the packet. The transmitter preferably continues this process until either the packet is (finally) correctly received, or the number of iterations has exceeded a predetermined threshold before proceeding to ready itself for its next original transmission.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A communication system, comprising:
a transmitter employing hybrid automatic repeat-request (HARQ) and able to retransmit an incorrectly received packet without differently re-encoding data bits, the transmitter further able to select at least one bit from any in a set to forward in at least one retransmission, the set containing any bits punctured from an original transmission corresponding to the retransmission.

2. The system of claim 1, wherein at least one of the bits selected for re-transmission was previously forwarded as part of a previous re-transmission.

3. The system of claim 1, wherein the set contains all of the bits punctured from original transmission corresponding to the retransmission.

4. The system of claim 1, wherein the transmitter further comprises multiple antennas.

5. The system of claim 1, wherein the transmitter further comprises at least one forward error correction (FEC) encoder.

6. The system of claim 1, wherein the transmitter is further able to use at least one IEEE 802.11 standard.

7. The system of claim 1, wherein the transmitter is part of a wireless local area network (WLAN).

8. The system of claim 1, wherein the transmitter is capable of ultra-wideband transmissions.

9. The system of claim 1, wherein the transmitter is able to retransmit an incorrectly received packet without re-encoding the data bits.

10. The system of claim 1, wherein the transmitter is able to retransmit an incorrectly received packet with re-encoded data bits, the re-encoded data bits identically encoded as in the original transmission.

11. The system of claim 1, wherein the transmitter transmits a medium access control (MAC) address in a physical (PHY) layer of a data frame of a transmission.

12. The system of claim 1, wherein the transmitter transmits at least one from the group of: HARQ indicator, temporary identification (TID) indicator, retransmission indicator, and puncturing bit indicator.

13. A method for communicating, comprising:
transmitting, by a transmitter using hybrid automatic repeat-request (HARQ), a packet containing at least one punctured bit;
selecting, by the transmitter and without differently re-encoding data bits, at least one bit from any in a set to forward in at least one retransmission of an incorrectly received packet, the set containing any bits punctured from an original transmission corresponding to the retransmission; and
retransmitting the packet with at least one different punctured bit.

14. The method of claim 13, further comprising receiving an indication that the first packet was not correctly received.

15. The method of claim 13, further comprising retransmitting the packet a further time with at least one further different punctured bit.

16. The method of claim 13, wherein the selecting further comprises selecting for a retransmission at least one of the bits previously forwarded as part of a previous retransmission.

17. The method of claim 13, wherein the selecting further comprises selecting from a set that contains all of the bits punctured from original transmission corresponding to the retransmission.

18. The method of claim 13, wherein the transmitting further comprises transmitting, by the transmitter, via multiple antennas.

19. The method of claim 13, wherein the transmitting further comprises transmitting, by the transmitter, by using at least one IEEE 802.11 standard.

20. The method of claim 13, wherein the transmitting further comprises transmitting as a part of a wireless local area network (WLAN).

21. The method of claim 13, wherein the transmitting further comprises transmitting, by the transmitter, using ultra-wideband.

22. The method of claim 13, wherein the selecting further comprises, selecting without re-encoding the data bits.

23. The method of claim 13, wherein the selecting further comprises, selecting with re-encoded data bits, the re-encoded data bits identically encoded as in the original transmission.

24. The method of claim 13, wherein the transmitting further comprises transmitting a medium access control (MAC) address in a physical (PHY) layer of a data frame of a transmission.

25. The method of claim 13, wherein the transmitting further comprises transmitting at least one from the group of: HARQ indicator, temporary identification (TID) indicator, retransmission indicator, and puncturing bit indicator.
